(19) United States
(12) Patent Application Publication
(10) Pub. No.: US 2008/0057232 A1
(43) Pub. Date: Mar. 6, 2008

(54) POROUS SWELLABLE INKJET RECORDING ELEMENT AND SUBTRACTIVE METHOD FOR PRODUCING THE SAME

(76) Inventors: Jeffrey W. Leon, Rochester, NY (US); Hwei-Ling Yau, Rochester, NY (US); James R. Bennett, Rochester, NY (US); John L. Pawlak, Rochester, NY (US)

Correspondence Address: Andrew J. Anderson;Patent Legal Staff, Eastman Kodak Company, 343 State Street, Rochester, NY, 14650-2201, US

(21) Appl. No.: 11/470,412

(22) Filed: Sep. 6, 2006

(51) Int. Cl. B41M 5/50

(52) U.S. Cl. 428/32.24

(57) ABSTRACT

The invention relates to an inkjet recording element that comprises, on a support, a porous hydrophilic image-receiving layer made by a subtractive method involving removal of water-insoluble polymeric latex from a coated non-porous layer to form the porous layer. Also disclosed is a method for making the inkjet recording element and a method of printing on such an inkjet recording

### FIELD OF THE INVENTION

The invention relates generally to the field of inkjet recording media and printing methods. More specifically, the invention relates to an inkjet recording element that comprises, on a support, a porous hydrophilic ink-receiving layer made by a subtractive method.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water, an organic material such as a monohydric alcohol, a polyhydric alcohol, or mixtures thereof.

An inkjet recording element typically comprises a support having on at least one surface thereof at least one ink-receiving layer. There are generally two types of ink-receiving layers. The first type of ink-receiving layer comprises a non-porous coating of a polymer with a high capacity for swelling and absorbing ink by molecular diffusion. Cationic or anionic substances may be added to the coating to serve as a dye fixing agent or mordant for a cationic or anionic dye. This coating is optically transparent and very smooth, leading to a high glossy “photo-grade” receiver. The swellable binder forms a barrier to air-borne pollutants that otherwise may degrade the image dye over time. However, with this type of ink-receiving layer, the ink is usually absorbed slowly into the ink-receiving layer and the print is not instantaneously dry to the touch. Inkjet media having a non-porous layer are typically formed of one or more polymeric layers that swell and absorb applied ink. Due to limitations of the swelling mechanism, this type of media is relatively slow to absorb the ink, but once dry, printed images are often stable when subjected to light and ozone.

The second type of ink-receiving layer comprises a porous coating of inorganic, polymeric, or organic-inorganic composite particles, a polymeric binder, and optional additives such as dye-fixing agents or mordants. These particles can vary in chemical composition, size, shape, and intra-particle porosity. In this case, the printing liquid is absorbed into the open pores of the ink-receiving layer to obtain a print that is instantaneously dry to the touch. However, with this type of ink-receiving layer, image dyes adsorbed to the porous particles are relatively exposed to air and may fade unacceptably in a short time. In other words, the ink is absorbed very quickly into the porous layer by capillary action, but the open nature of the porous layer can contribute to instability of printed images, particularly when the images are exposed to environmental gases such as ozone.

In summary, the porous ink-jet recording media have excellent drying properties, but generally suffer from dye fading, whereas, the swellable type of ink-jet recording media may give less dye fading, but generally dry more slowly.

There remains a need for ink-jet recording media having excellent drying properties and, at the same time, showing minimal dye fading. In addition, these ink jet recording media should preferably have properties such as suitable durability, good sheet feeding property in ink-jet printers, good image density, as well as good image quality, preferably photographic image quality. Finally, the inkjet recording media should be easily manufacturable. It is towards fulfilling this need that the present invention is directed.

Prior attempts have been made to form an ink-receiving layer that is both porous and swellable, with the goal of providing quick dry time and also improved protection against dye fading. Thus, for example, commonly assigned US Publication No. 2004/0027440, published Feb. 12, 2004, discloses inkjet media having a porous hydrophilic polymer layer that enables faster absorption of the ink compared to a pure non-porous hydrophilic polymer layer, whilst still maintaining the image stability that is achieved from a non-porous medium. However, the method of manufacture for such media involves the use of blowing agents. By using blowing agents in conjunction with a hydrophilic polymer e.g. a swellable hydrophilic polymer, a swellable porous medium is produced. This results in improved absorption of the ink and dye within the ink. Instead of the dye being held in pores located between particles (which is the case for traditional porous media), the dye is located within the polymer, thereby improving image stability. Potential problems or limits with this approach, in general, are cell (or void) sizes that are too large, poor connectivity between cells, and overly wide cell size distribution.

Commonly assigned U.S. Ser. No. 11/210,169, filed Aug. 23, 2005, discloses an inkjet recording element comprising a support having thereon a swellable, porous image-receiving layer comprising at least one hydrophilic thermoplastic polymer, in a continuous phase, and interconnecting voids (also known as open-cell voiding), where voids contain inorganic and/or organic void initiating particles. This is created by the extrusion of a layer of hydrophilic polymer, optionally co-extruding with an underlying layer that may or may not be voided, and then stretching. Potential problems with the extrusion approach are, again, large cell size, low interconnectivity and, in addition, the presence of a voiding agent within the cells which lowers space available for ink absorption.

WO 2004/050379 discloses an ink jet recording medium comprising a porous water-swellable ink-receiving layer, adhered to a support, comprising a water-swellable polymer and pores/voids, preferably characterized by a void volume between 1 to 80 volume percent of the ink-receiving layer. The voids in such recording media may be introduced therein by several methods. For example, the voids in the ink-receiving layer of the media may be the result of gas bubbles present in the polymer solution when preparing the water-swellable ink receiving polymer layer. Alternatively, WO 2004/050379 states that the voids may result from droplets of a liquid that is poorly miscible with the solution of the material from which the water-swellable layer is made. By subsequently removing the poorly miscible liquid, while the material forming the water-swellable layer is allowed to maintain its shape, a porous water swellable layer may be obtained. Still alternatively, or in addition, the pores may be created in the ink-receiving layer by starting from solid particles and/or gas-generating compounds (such as certain salts). In summary, WO 2004/050379 proposes that void generating compounds can be selected from the following possibilities: (1) a formulation comprising at least one organic solvent followed by evaporation of the organic solvent, (2) a gas that is incorporated in an aqueous formulation which forms voids, (3) fine solid particles that are dissolved in a suitable solvent, and (4) a gas-generating agent that is reacted with a compound to produce gas therefrom, and combinations thereof. All of these proposed methods of void formation have problems or limitations, one of the foremost being the difficulty and expense of manufacture, compared to typical inkjet media manufacture. Other problems involve the difficulty of controlling void generation.

Other specific methods for forming a porous layer with a hydrophilic matrix, either in or outside the context of inkjet media are known. For Example, Lakes in U.S. Pat. No. 4,226,886 describes a method for producing an ink pad containing voids by mixing a polymer with inorganic salt particles of size 2 to 450 micrometers, extruding a desired shape with a more dense skin portion formed on the pad, cutting and finishing the pad, then leaching out the salt over a period of 24 to 48 hours in a hot water bath, followed by rinsing for two to four hours. A leach and rinse process is not practical for economic production of inkjet receivers.

Haruta et al. in JP 58-136,478 describe a recording sheet for inkjet recording comprising a porous resin layer produced by kneading a resin with particulates of a water-soluble inorganic salt, molding an article, and then immersing the article in water to dissolve the inorganic salt. Immersion of the article to wash out the salt requires a drying step.

Miazaki et al. in JP 61-037,827 disclose a synthetic resin film with a network structure formed by mixing a thermoplastic resin powder with inorganic powder and a plasticizer such as dibutylphthalate, forming a film, and extracting the plasticizer and, if necessary, part of the powder. A void ratio of 30 to 98% and an average pore size of 0.5 to 2.0 microns are obtained. Extraction of a high-boiling solvent is impractical for producing large quantities of an inkjet receiver.

Hmelar et al. in EP 304,482 disclose a tubing article with an outer printable layer formed by a extruding a blend of polymer and NaCl particles and leaching by immersion in water. Immersion processes are not practical at high coating speeds.

Ma in U.S. Pat. No. 6,673,285 describes a method for forming a 3-D porous polymeric material. The molding and days-long solvent extraction processes disclosed are not practical for efficiently producing thin ink-receptive layers.

Yamauchi et al. in JP 2004-155,137 disclose an inkjet recording medium and its manufacturing method. In this method, particles of the salt of a polyvalent metal soluble in acid (such as calcium carbonate) are coated in a hydrophilic binder such as poly(vinyl alcohol). After drying of the coating, spray coating of an aqueous acid dissolves the salt particles to form voids. The polyvalent metal ion provides an ink-fixing property. Also disclosed is the incorporation of additional, non-soluble particles to support the void structure during dissolution of the acid-soluble particles.

Toda et al. in WO 2004-050,379 similarly disclose a coating of a dispersion of a solid material in water further comprising a water-soluble polymer. After at least partial drying, the particles are dissolved by contacting with (for example, immersing in) dilute acid, leaving a voided, water-swellable layer.

In view of the above, the prior art methods for making inkjet media that are both porous and swellable are problematic, disadvantageous, or impractical for economic manufacture.

### SUMMARY OF THE INVENTION

The present invention is directed to overcoming one or more of the problems set forth above. An objective of the present invention is thus to provide an ink jet medium better suited to produce photographic quality images. It is another objective of this invention to provide an ink jet recording medium having improved drying characteristics. It is yet another objective of this invention to provide an ink-jet recording medium having excellent dye fading resistance. It has been found that these objectives can be met by providing an inkjet recording medium comprising a porous water-swellable ink-receiving layer over a support, in particular a porous water-swellable ink-receiving layer made by an advantageous subtractive method according to the present invention.

In particular, the present invention is directed to a method of making a porous swellable inkjet recording element comprising the steps of (implicitly not necessarily in the following order):

(a) providing a support,

(b) coating a first aqueous composition comprising particles and a polymeric binder on the support to form at least one porous underlying layer when dried,

(c) coating above the underlying layer a second aqueous composition comprising a hydrophilic polymeric binder and a dispersion of water-insoluble polymeric latex to form a non-porous upper layer when dried,

(d) either sequentially or simultaneously drying the first aqueous coated composition to form the porous underlying layer, either before or after coating the second aqueous coating composition, and the second aqueous coated composition to form the non-porous upper layer, thereby forming a coated support that is an manufacturing intermediate of the inkjet recording element,

(e) applying to the coated support of step (d) solvent for the water-insoluble polymeric latex, for a sufficient amount of time, to solubilize and transport a substantial portion of the water-insoluble polymeric latex from the non-porous upper layer, thereby forming after removing solvent an inkjet recording element comprising an image-receiving layer comprising a porous water-swellable polymeric matrix.

Accordingly, the present invention, the matrix of the image-receiving layer (IRL) comprises a water-swellable polymer that can be any suitable water-swellable polymer known in the art. Preferably poly(vinyl alcohol) is used for this purpose. Any suitable material may be used as the support. Possible examples include resin-coated paper, coated paper, and treated paper.

In one preferred embodiment, the method comprises applying an amount of solvent that is sufficient to cause a sufficient amount of the water-insoluble polymeric latex to migrate to the underlying porous layer to render the non-porous layer effectively porous. Factors such as the solubility of polymer latex in the choice of organic solvent, the amount of solvent applied, the viscosity of resulting polymer solution, and the drying rate all have significant influence on the effectiveness of polymer migration from the surface layer.

An inkjet recording element according to one embodiment of the present invention comprises a support and, coated over the support, in order:

(a) an underlying porous layer comprising less than 35 percent by weight of a polymeric binder, greater than 65 percent by weight of particles and, interstitially located in the pores formed by the particles, water-insoluble polymer latex;

(b) a porous water-swellable image-receiving layer comprising at least one water-swellable hydrophilic polymer,

wherein there is a gradient of said water-insoluble polymer latex in the underlying porous layer that decreases in the direction of the support, resulting from diffusion of said water-insoluble polymer latex when organic-containing solvent was applied to the upper surface of the coated material during the manufacture of the inkjet recording element.

Yet another aspect of the invention relates to an inkjet printing method comprising the steps of: A) providing an inkjet printer that is responsive to digital data signals; B) loading the inkjet printer with the inkjet recording element described above or made as described above; C) loading the inkjet printer with an inkjet ink; and D) printing on the inkjet recording element using the inkjet ink in response to the digital data signals.

Without wishing to be bound by theory, it is believed that the open-cells in the hydrophilic material in the image-receiving layer may collapse, at least to some extent, when ink is applied during inkjet printing, due to water in the ink composition swelling and softening the hydrophilic polymer. The collapsing of the open cells may not only be responsible for the improved image density, but may also provide a barrier to ozone relative to air, thereby reducing ozone fade.

### ADVANTAGEOUS EFFECTS OF THE INVENTION

The present invention includes several advantages, not all of which may be incorporated in a single embodiment. The present invention provides an inkjet media that enables faster absorption of the ink compared to a pure non-porous hydrophilic polymer layer, whilst still maintaining the image stability that is achieved from a non-porous medium. When compared to a conventional porous medium, the medium of the present invention shows significant improvements in image stability.

By using solvent extraction of low-molecular weight latex in conjunction with a swellable hydrophilic polymer, a swellable porous medium is produced that results in improved absorption of dye-based ink. However, instead of the dye being held in pores that are located between particles (which is the case for traditional porous media), dye is located within the polymer, thereby improving image stability. Resulting images were tested for ozone fade and found to be significantly superior relative to commercial porous instant-dry inkjet media.

In describing the invention herein, the following definitions generally apply:

The term “porous layer” is used herein to define a layer that is characterized by absorbing applied ink by means of capillary action to a significant extent. An inkjet recording element having one or more porous layers, preferably substantially all layers, over the support can be referred to as a “porous inkjet recording element,” even though at least the support is not considered porous.

Particle sizes referred to herein, unless otherwise indicted, are median particle sizes as determined by light scattering measurements of diluted particles dispersed in water, as measured using photon correlation spectroscopy (PCS) or MIE scattering techniques employing a NANOTRAC (Microtac Inc) ultrafine particle analyzer or a Horiba LA-920 instrument, respectively. Unless otherwise indicated particle sizes refer to secondary particle size.

As used herein, the terms “over,” “above,” “upper,” “under,” “below,” “lower,” and the like, with respect to layers in inkjet media, refer to the order of the layers over the support, but do not necessarily indicate that the layers are immediately adjacent or that there are no underlying layers.

In regard to the present method, the term “image-receiving layer” is intended to define a layer that can be used as a dye-trapping layer, or dye-and-pigment-trapping layer, in which the printed image substantially resides throughout the layer. Preferably, an image-receiving layer comprises a mordant for dye-based inks. The image may optionally reside in more than one image-receiving layers.

In regard to the present method, the term “porous underlying layer” (sometimes also referred to as a “sump layer” or “ink-carrier-liquid receptive layer”) is used herein to mean a layer, under the upper image-receiving layer, that absorbs a substantial amount of ink-carrier liquid. In use, a substantial amount, preferably most, of the carrier fluid for the ink is received in the one or more underlying layers. An underlying layer is not above an image-containing layer and is not itself an image-containing layer (a pigment-trapping layer or dye-trapping layer). Preferably, in the case of a single underlying layer, the underlying layer is an ink-receptive layer that is immediately adjacent the support, not including subbing layers or the like that are not significantly absorbent. A porous underlying layer, since the porosity is based on pores formed by the spacing between particles, (although porosity can be affected by the particle to binder ratio), is referred to as a “particle-based porous underlying layer,” as compared to a voided matrix. The porosity of such a layer may be predicted based on the critical pigment volume concentration (CPVC).

The term “ink-receptive layer” or “ink-retaining layer” includes any and all layers above the support that are receptive to an applied ink composition, that absorb or trap any part of the one or more ink compositions used to form the image in the inkjet recording element, including the ink-carrier fluid and/or the colorant, even if later removed by drying. An ink-receptive layer, therefore, can include an image-receiving layer, in which the image is formed by a dye and/or pigment, a porous underlying layer, or any additional layers, for example between a porous underlying layer and a topmost layer of the inkjet recording element.

Typically, all layers above the support are ink-receptive. The support on which ink-receptive layers are coated may also absorb ink-carrier fluid, in which it is referred to as an ink-absorptive or absorbent layer rather than an ink-receptive layer.

### DETAILED DESCRIPTION OF THE INVENTION

As indicated above, one aspect of the present invention is directed to a method of making a porous swellable inkjet recording element comprising coating a first aqueous composition, comprising particles and a polymeric binder, onto a support to form at least one porous underlying layer when dried, then coating above the underlying layer a second aqueous composition comprising a hydrophilic polymeric binder and a dispersion of water-insoluble polymeric latex to form a non-porous upper layer when dried, and finally, after drying the coated compositions to form a porous underlying layer and a non-porous upper layer, applying solvent for the water-insoluble polymeric latex to the coated layers to transport a substantial portion of the water-insoluble polymeric latex from the non-porous upper layer, thereby forming an image-receiving layer comprising a porous water-swellable polymeric matrix.

Various methods may be used for applying solvent to the coated material. For example, one embodiment involves applying, to the upper surface of the coated support, an amount of solvent not exceeding an amount that would run off the surface of the coated support. Accordingly, the amount of solvent would be more than an amount that would completely saturate the intermediate material. The solvent can be applied to the coated support by contact with another solvent-containing material, by spraying a solvent, by immersion in a solvent, etc. In one particular embodiment, solvent causes sufficient water-insoluble polymeric latex to migrate to the underlying porous layer to render the non-porous layer effectively porous, thereby not removing the water-insoluble latex from the final inkjet recording element. In contrast, when the water-insoluble polymer latex is removed from the image-receiving layer by immersion of the coated support in solvent, water-insoluble polymeric latex is removed from the inkjet recording element altogether.

In still another embodiment, the solvent for removing water-insoluble polymer latex can be applied onto a coated support that is facing downwards, such that gravity facilitates the fall or removal of solvent containing dissolved water-insoluble latex from the coated support. For example, during manufacture, the coated support can be a continuous web in which the top of the coated support is facing substantially downwards while a spray means positioned beneath the continuous web impinges solvent onto the surface of the coated support.

A homogeneous aqueous coating composition for the image-receiving layer comprising the water-swellable polymer and a latex polymer can be made optionally comprising one or more pigments, surfactants, cross-linking agents, plasticizers, fillers. After the coating for the image-receiving layer is applied and dried over the support, the latex is extracted from its original location by treatment with an organic-containing solvent, that is, a solvent primarily comprising one or more organic-solvent compounds, optionally with a minor amount of water, preferably less than 10 percent by weight water. The organic solvent (comprising one or more organic compounds) can be any suitable solvent, which can dissolve the latex and has a boiling point preferably below 120° C. for easy drying. Preferably the solvent will not appreciably swell the water-soluble binder. Depending on the latex polymer, one can use very non-polar solvents like hexane or pentane, or less non-polar solvents such as ethyl acetate. Preferably solvents such as 2-butanone, acetone, ethyl acetate, or toluene or the like are used. Solvent mixtures can be used to tailor the properties of the overall solvent. These organic solvents can comprise agents to adjust the subtractive power and/or to modify the pore formation of the image-receiving layer.

In the case of transporting the latex from its original location to a different location in the inkjet recording element, the organic solvent will thereafter evaporate. Optionally, the coated material can be heated and/or subjected to reduced pressure to facilitate evaporation of the organic solvent. In any case, the voids left by the removal of the latex by the solvent provide for the porous structure of the upper layer of the present invention.

The hydrophilic polymer used in the above-mentioned method comprises a polymer that is soluble in water, at least before optional crosslinking in the image-receiving layer. Water-soluble polymers suitable for this purpose include, but are not limited to, homopolymers and copolymers such as hydrophilic organic polymers and lightly crosslinked hydrogels, for example, polyvinylpyrrolidone and vinylpyrrolidone-containing copolymers, polyethyloxazoline and oxazoline-containing copolymers, imidazole-containing polymers, polyacrylamides and acrylamide-containing copolymers, poly(vinyl alcohol) and vinyl-alcohol-containing copolymers, poly(vinyl methyl ether), poly(vinyl ethyl ether), poly(alkylene oxide), gelatin and derivatives thereof, cellulose ethers, poly(vinylacetamides), partially hydrolyzed poly(vinyl acetate/vinyl alcohol), poly(acrylic acid), sulfonated or phosphated polyesters and polystyrenes, casein, albumin, chitin, chitosan, dextran, pectin, collagen derivatives, collodian, agar-agar, arrowroot, guar, carrageenan, tragacanth, xanthan, rhamsan and the like, hydroxyethyl cellulose, hydroxypropyl cellulose, hydroxypropyl methyl cellulose, methyl cellulose, and poly(alkylene oxide). Mixtures of the above listed hydrophilic polymers can be used.

The hydrophilic polymer in the image-receiving layer is preferably selected from the group consisting of gelatin, polyvinylpyrrolidinone (PVP), and poly(vinyl alcohol), and derivatives and copolymers of the foregoing and combinations thereof. Poly(vinyl alcohol) derivatives and copolymers include, for example, copolymers of poly(ethylene oxide) and poly(vinyl alcohol) (PEO-PVA) and copolymers of poly(ethylene vinyl alcohol) and poly(vinyl alcohol). Derivitized poly(vinyl alcohol) includes, for example, polymers having at least one hydroxyl group replaced by ether or ester groups, which may be used in the invention, for example an acetoacetylated poly(vinyl alcohol). Another copolymer of poly(vinyl alcohol), for example, is carboxylated PVA in which the acid group is present in a comonomer.

There are a variety of gelatins or modified gelatins, which can be used. For example: alkali-treated gelatin (cattle bone or hide gelatin) or acid-treated gelatin (pigskin gelatin), gelatin derivatives such as acetylated gelatin, phthalate gelatin and the like.

Preferred poly(vinyl alcohol) polymers and copolymers thereof have a degree of hydrolysis of preferably at least about 75%, more preferably at least 88 percent. Commercial embodiments of such poly(vinyl alcohol) and copolymers are readily available from various suppliers. Suitable PVA copolymers may, for example, have a degree of polymerization of at least 500, preferably less than 5000.

The water-soluble polymers in the porous water-swellable ink receiving layer(s) are preferably used in a total amount of from 1 to 30 g/m², and more preferably from 2 to 20 g/m².

If desired, the water-soluble hydrophilic polymers can be cross-linked in the inkjet recording elements of the present invention in order to impart mechanical strength to the layer. Any suitable cross-linking agent known in the art can be employed. Such an additive can improve the adhesion of a layer to the substrate as well as contribute to the cohesive strength and water resistance of the layer. Cross-linkers such as carbodiimides, polyfunctional aziridines, melamine formaldehydes, isocyanates, epoxides, and the like may be used. Other crosslinkers include, for example, borax, tetraethyl orthosilicate, 2,3-dihydroxy-1,4-dioxane (DHD) or any other suitable crosslinker may be added to the polymer to provide an amount of crosslinking to the polymeric layer.

Preferably, the at least one hydrophilic polymer is inherently capable of gaining greater than 30 w % by weight of water by absorption over 24 hours at 25° C.

The water-insoluble polymer latex is selected so that it is effectively soluble in the solvent used for its removal from the image-receiving layer. For example, the weight average molecular weight of water-insoluble polymer latex is sufficiently low to allow a substantial portion to be effectively solubilized and transported by the solvent from the non-porous upper layer. A suitable weight average molecular weight may therefore depend on the composition and structure of the latex and the choice of solvent. In general, the weight average molecular weight of water-insoluble polymer latex is preferably less than 250,000, more preferably less than 100,000. However, when the water-insoluble polymer latex is polystyrene or a copolymer thereof, the weight average molecular weight is preferably less than 25,000, more preferably less than 16,000. On the other hand, a more polar latex material such as PMMA may have a higher preferred molecular weight.

In a preferred embodiment, the water-insoluble latex is essentially non-crosslinked, a linear or branched polymer.

The water-insoluble latex has a median particle size in dispersion of less than 1 micrometer, preferably less than 500 nm, and more preferably less than 250 nm. Any suitable hydrophobic, water-insoluble latex can be employed. Lattices are addition polymers made from ethylenically unsaturated monomers, in one embodiment preferably from styrene homopolymers or copolymers and poly(methylmethacrylate) or copolymers are especially preferred. Thus, the water-insoluble latex is preferably a copolymer or polymer comprising monomeric units that are the reaction product of monomers selected from the group consisting of acrylic, methacrylic, or styrenic monomers. Alternately, N-alkyl or N-aryl acrylamides or methacrylamides can be used provided that they contain hydrophobic substituents which are of sufficient size as to impart organic solubility to the latex. Alternate monomers may include unsaturated hydrocarbons (such as butadiene or isoprene), vinyl halides, vinyl esters, or vinyl ethers. However, other lattices can be used which are insoluble in water but which are capable of being extracted in an organic solvent.

The latex material may be considered to serve as a template material for the voids formed in the image-receiving layer. When this latex material has been removed, by suitable solvent, from the water-swellable polymeric matrix, then a plurality of voids remain in their desired number, shape and dimensions. In a preferred embodiment, the weight ratio of water-insoluble polymeric latex to hydrophilic binder is from 10:1 to 1:1, more preferably from 6:1 to 2:1.

The solvent used in the present method is capable of effectively solubilizing the water-insoluble latex but effectively not solubilizing the hydrophilic binder, which is optionally crosslinked. The solvent comprises at least one organic compound. Preferably the organic compound is a solvent that is not of greater polarity than acetone according to conventional solubility parameter measurements. The solvent can be miscible in water, for example THF or acetone, or can be immiscible in water. If miscible, the solvent may include a minor amount of water.

The organic solvent solution used in the present invention is used to extract the latex from its original location in the coated layer for the IRL. After extraction by the solvent, the latex will leave voids, creating a porous structure. In one embodiment, the organic solvent comprises one or more organic compounds, preferably all organic compounds, having a boiling point less than 120° C., preferably a boiling point between 40° C. and 110° C.

Examples of suitable solvents include, but are not limited to, acetone, 2-butanone, ethyl acetate, propyl acetate, THF, heptane, hexane, methylene chloride, chloroform, toluene, and the like and mixtures of these solvents.

Another aspect of the present invention is directed to an inkjet recording element comprising a support and, coated over the support, in order:

(a) an underlying porous layer comprising less than 35 percent by weight of a polymeric binder, greater than 65 percent by weight of particles and, interstitially located in the pores formed by the particles, water-insoluble polymer latex;

(b) a porous water-swellable image-receiving layer comprising at least one water-swellable hydrophilic polymer,

wherein there is a gradient of said water-insoluble polymer latex in the underlying porous layer that decreases in the direction of the support, resulting from diffusion of said water-insoluble polymer latex when organic solvent was applied to the upper surface of the coated material during the manufacture of the inkjet recording element.

For example, a common gradient would be such that the porous water-swellable image-receiving layer comprises less water-insoluble polymer latex in the top half of the upper layer, and the underlying porous layer comprises more water-insoluble polymer latex in the top half of the layer.

A dye mordant can be employed in any of the ink-retaining layers, but usually at least the image-receiving upper layer and optionally also the underlying layer. The mordant can be any material that is substantive to the inkjet dyes. Examples of such mordants include cationic lattices such as disclosed in U.S. Pat. No. 6,297,296 and references cited therein, cationic polymers such as disclosed in U.S. Pat. No. 5,342,688, and multivalent ions as disclosed in U.S. Pat. No. 5,916,673, the disclosures of which are hereby incorporated by reference. Examples of these mordants include polymeric quaternary ammonium compounds, or basic polymers, such as poly(dimethylaminoethyl)-methacrylate, polyalkylenepolyamines, and products of the condensation thereof with dicyanodiamide, amine-epichlorohydrin polycondensates. Further, lecithins and phospholipid compounds can also be used. Specific examples of such mordants include the following: vinylbenzyl trimethyl ammonium chloride/ethylene glycol dimethacrylate; poly(diallyl dimethyl ammonium chloride); poly(2-N,N,N-trimethylammonium)ethyl methacrylate methosulfate; poly(3-N,N,N-trimethyl-ammonium)propyl methacrylate chloride; a copolymer of vinylpyrrolidinone and vinyl(N-methylimidazolium chloride; and hydroxyethylcellulose derivatized with 3-N,N,N-trimethylammonium)propyl chloride. In a preferred embodiment, the cationic mordant is a quaternary ammonium compound.

Alternately, mordants based on soft organic anions, such as sulfonates may be employed if an ink set comprising colorants with cationic moieties is used.

In order to be compatible with the mordant, both the binder and the polymer in the layer or layers in which it is contained should be either uncharged or the same charge as the mordant. Colloidal instability and unwanted aggregation could result if a polymer or the binder in the same layer had a charge opposite from that of the mordant.

In one embodiment, the porous upper image receiving-layer may independently comprise dye mordant in an amount ranging from about 2 parts to about 40 percent by weight of the layer, preferably 5 to 25 percent. The upper layer preferably is the layer containing substantially the highest concentration and amount of polymeric mordant.

In another embodiment, the inkjet recording element comprises, in the image-receiving layer, non-solvent-removable particles having a median particle size of 5 to 150 nm, to enhance voiding by reducing the degree of void collapse after removal of the water-insoluble polymer latex by solvent treatment during formation of the image-receiving layer. In one embodiment, particles of a hydrated or unhydrated metal oxide, for example, colloidal alumina hydrate, is used in an amount of between 5 to 30 weight percent. Similar effects were seen with fumed aluminas and fumed silicas used in combination with latex porogens of the invention.

Since the inkjet recording element may come in contact with other image recording articles or the drive or transport mechanisms of image-recording devices, additives such as surfactants, lubricants, matte particles and the like may be added to the inkjet recording element to the extent that they do not degrade the properties of interest.

The coating composition for the image-receiving layer may contain various particulate (i.e., pigments) to provide the medium with anti-blocking properties to prevent ink from transferring from one medium to an adjacent medium during imaging of the media. Further additives, such as white pigments, color pigments, fillers, especially absorptive fillers and pigments such as oxides, carbonates, silicates or sulfates of alkali metals, earth alkali metals such as silicic acid, aluminum oxide, barium sulfate, calcium carbonate and magnesium silicate, alumina, aluminum hydroxide, pseudoboehmite. Further additives such as color fixation agents, dispersing agents, softeners and optical brighteners can be contained in the polymer layer. Titanium dioxide can be used as a white pigment. Further fillers and pigments are calcium carbonate, magnesium carbonate, clay, zinc oxide, aluminum silicate, magnesium silicate, ultramarine, cobalt blue, and carbon black or mixtures of these materials. The fillers and/or pigments are used as additives in quantities of 0 to 20 wt. %. The quantities given are based on the mass of the polymer layer.

Further examples of inorganic and organic particulate include zinc oxide, tin oxide, silica-magnesia, bentonite, hectorite, poly(methyl methacrylate), and poly(tetrafluoroethylene). In order not to impair the gloss of the recording material, the pigment used within the image-receiving layer may be a finely divided inorganic pigment with a particle size of 0.01 to 1.0 μm, especially 0.02 to 0.5 μm. Especially preferred, however, is a particle size of 0.1 to 0.3 μm. Especially well suited are silicic acid and aluminum oxide with an average particle size of less than 0.3 μm. However, a mixture of silicic acid and aluminum oxide with an average particle size of less than 0.3 μm can also be employed.

Matte particles may be added to any or all of the layers described in order to provide enhanced printer transport, resistance to ink offset, or to change the appearance of the image-receiving layer to satin or matte finish. Typical additives can also include antioxidants, process stabilizers, UV absorbents, UV stabilizers, antistatic agents, anti-blocking agents, slip agents, colorants, foaming agents, plasticizers, optical brightening agents, flow agents, and the like.

Optional other layers, including subbing layers, overcoats, further underlying layers between the support and the upper image-receiving layer or layers, etc. may be coated by conventional coating means onto a support material commonly used in this art.

Coating compositions employed in the invention may be applied by any number of well known techniques, including dip-coating, wound-wire rod coating, doctor blade coating, gravure and reverse-roll coating, slide coating, bead coating, extrusion coating, curtain coating and the like. Known coating and drying methods are described in further detail in Research Disclosure no. 308119, published December 1989, pages 1007 to 1008. Some of these methods allow for simultaneous coatings of two or more layers, which is preferred from a manufacturing economic perspective. For example, slide coating may be used, in which the layers may be simultaneously applied. After coating, the layers are generally dried by simple evaporation, which may be accelerated by known techniques such as convection heating.

In the final product, the porous layers above the support contains interconnecting voids that can provide a pathway for the liquid components of applied ink to penetrate appreciably, thus allowing the one or more underlying layers to contribute to the dry time. A non-porous layer or a layer that contains closed cells would not allow underlying layers to contribute to the dry time.

In a preferred embodiment of the invention, the inkjet recording element further comprises, over the support, at least one porous ink-receiving underlying layer, optionally divided into one or more sub-layers, comprising greater than 50 percent, by weight of the layer, of particles of one or more second materials, wherein the average pore size of the layer is 10 to 1000 nm, preferably 20 to 500 nm, as measured by standard techniques such as mercury intrusion porosimetry or by nitrogen BET. Preferably the absorption capacity of the one or more underlying layers is in total at least 10 cc/m², preferably at least 20 cc/mm².

In a preferred embodiment, the underlying layer is made using a coating composition comprising inorganic particles, binder, and surfactant, wherein the underlying layer comprises greater than 50 percent by weight, preferably greater than 80 weight percent of the solids, of particles of one or more base-layer materials having an average particle size of under 5 micrometers.

In one embodiment, the inkjet recording element comprises more than one porous underlying layer, in which a latex-absorbing porous underlying layer is present for absorbing the water-insoluble latex polymer when organic-containing solvent is applied to the upper surface of the coated material during its manufacture. Such a latex-absorbing porous underlying layer is located between the image-receiving layer and a lower porous underlying layer. The latex-absorbing porous underlying layer is relatively thin and has a relatively larger average pore diameter compared to the lower porous underlying layer (for example, a base layer immediately adjacent the support), which larger average pore diameter can, for example, be obtained by including less binder or larger particles

Preferably, the one or more second materials in the ink-receiving underlying layer or layers comprise particles of hydrated or unhydrated metallic oxide or semi-metallic oxide such as silicon dioxide.

Metallic-oxide and semi-metallic oxide particles can be divided roughly into particles that are made by a wet process and particles made by a dry process (vapor phase process). The latter type of particles is also referred to as fumed or pyrogenic particles. In a vapor phase method, flame hydrolysis methods and arc methods have been commercially used. Fumed particles exhibit different properties than non-fumed or hydrated particles. In the case of fumed silica, this may be due to the difference in density of the silanol group on the surface. Fumed particles are suitable for forming a three-dimensional structure having high void ratio.

Fumed or pyrogenic particles are aggregates of smaller, primary particles. Although the primary particles are not porous, the aggregates contain a significant void volume, and hence are capable of rapid liquid absorption. These void-containing aggregates enable a coating to retain a significant capacity for liquid absorption even when the aggregate particles are densely packed, which minimizes the inter-particle void volume of the coating. For example, fumed alumina particles, for selective optional use in the present invention, are described in US20050170107 A1, hereby incorporated by reference.

More preferably, the underlying layer comprises substantially non-aggregated colloidal particles that comprise silica or hydrated or unhydrated alumina. Most preferably, the one or more materials comprise a hydrated alumina that is an aluminum oxyhydroxide material, for example, boehmite and the like.

The term “hydrated alumina” is herein defined by the following general formula:

Al₂O₃₋ₙ(OH)₂ₙmMH₂O

wherein n is an integer of 0 to 3, and m is a number of 0 to 10, preferably 0 to 5. In many cases, mH₂O represents an aqueous phase, which does not participate in the formation of a crystal lattice, but is able to be eliminated. Therefore, m may take a value other than an integer. However, m and n are not 0 at the same time.

The term “unhydrated alumina” is herein defined by the above formula when m and n are both zero at the same time and includes fumed alumina, made in a dry phase process or anhydrous alumina Al₂O₃ made by calcining hydrated alumina. As used herein, such terms as unhydrated alumina apply to the dry materials used to make coating compositions during the manufacture of the inkjet recording element, notwithstanding any hydration that occurs after addition to water.

A crystal of the hydrated alumina showing a boehmite structure is generally a layered material the (020) plane of which forms a macro-plane, and shows a characteristic diffraction peak. Besides a perfect boehmite, a structure called pseudo-boehmite and containing excess water between layers of the (020) plane may be used. The X-ray diffraction pattern of this pseudo-boehmite shows a diffraction peak broader than that of the perfect boehmite. Since perfect boehmite and pseudo-boehmite may not be clearly distinguished from each other, so the term “boehmite” or “boehmite structure” is herein used to include both unless indicated otherwise by the context. For the purposes of this specification, the term “boehmite” implies boehmite and/or pseudoboehmite.

Boehmite and pseudoboehmite are aluminum oxyhydroxides, which is herein defined by the general formula γ-AlO(OH) xH₂O, wherein x is 0 to 1. When x=0 the material is specifically boehmite as compared to pseudo-boehmite; when x>0 and the materials incorporate water into their crystalline structure, they are known as pseudoboehmite. Boehmite and pseudoboehmite are also described as Al₂O₃.zH₂O where, when z=1 the material is boehmite and when 1<z<2 the material is pseudoboehmite. The above materials are differentiated from the aluminum hydroxides (e.g. Al(OH)₃, bayerite and gibbsite) and diaspore (α-AlO(OOH) by their compositions and crystal structures. As indicated above, boehmite is usually well crystallized and, in one embodiment, has a structure in accordance with the x-ray diffraction pattern given in the JCPDS-ICDD powder diffraction file 21-1307, whereas pseudoboehmite is less well crystallized and generally presents an XRD pattern with relatively broadened peaks with lower intensities.

The term “aluminum oxyhydroxide” is herein defined to be broadly construed to include any material whose surface is or can be processed to form a shell or layer of the general formula γ-AlO(OH) xH₂O (preferably boehmite), such materials including aluminum metal, aluminum nitride, aluminum oxynitride (AlON), α-Al₂O₃, γ-Al₂O₃, transitional aluminas of general formula Al₂O₃, boehmite (γ-AlO(OH)), pseudoboehmite ((γ-AlO(OH)).x H₂O where 0<x<1), diaspore (α-AlO(OH)), and the aluminum hydroxides (Al(OH)₃) of bayerite and gibbsite. Thus, aluminum oxyhydroxide particles include any finely divided materials with at least a surface shell comprising aluminum oxyhydroxide. In the most preferred embodiment, the core and shell of the particles are both of the same material comprises boehmite with a BET surface area of over 100 m²/g.

The underlying layer can also or alternatively comprise other inorganic particles, for example, calcium carbonate, magnesium carbonate, insoluble sulfates (for example, barium or calcium sulfate), hydrous silica or silica gel, silicates (for example aluminosilicates), titanium dioxide, talc, and clay or constituents thereof (for example, kaolin or kaolinite). Admixtures of two different precipitated calcium carbonate particles, of different morphologies, can be employed.

Examples of organic particles that may be used in the underlying layer include polymer beads or particles, for example, crosslinked styrenic particles, not softened by the solvent/drying operation. Hollow styrene beads may be preferred organic particles for certain applications.

Other examples of organic particles, which may be used, include core/shell particles such as those disclosed in U.S. Pat. No. 6,492,006 and homogeneous particles such as those disclosed in U.S. Pat. No. 6,475,602, the disclosures of which are hereby incorporated by reference.

In one particular preferred embodiment of the invention, the underlying layer comprises between 75% by weight and 98% by weight of particles and between about 2% and 25% by weight of a polymeric binder, preferably from about 82% by weight to about 96% by weight of particles and from about 18% by weight to about 4% by weight of a polymeric binder, most preferably about 4 to 10% by weight of binder.

As mentioned above, the amount of binder is desirably limited, because when ink is applied to inkjet media, the (typically aqueous) liquid carrier tends to swell the binder and close the pores and may cause bleeding or other problems. Preferably, therefore, the underlying layer comprises less than 25 weight percent of binder, to maintain porosity, although higher levels of binder may be used in some cases to prevent cracking.

Any suitable polymeric binder may be used in the underlying layer of the inkjet recording element employed in the invention. In a preferred embodiment, the polymeric binder may be a compatible, preferably hydrophilic polymer such as poly(vinyl alcohol), poly(vinyl pyrrolidone), gelatin, cellulose ethers, poly(oxazolines), poly(vinylacetamides), partially hydrolyzed poly(vinyl acetate/vinyl alcohol), poly(acrylic acid), poly(acrylamide), poly(alkylene oxide), sulfonated or phosphated polyesters and polystyrenes, casein, zein, albumin, chitin, chitosan, dextran, pectin, collagen derivatives, collodian, agar-agar, arrowroot, guar, carrageenan, tragacanth, xanthan, rhamsan and the like. Preferably, the hydrophilic polymer is poly(vinyl alcohol), hydroxypropyl cellulose, hydroxypropyl methylcellulose, a poly(alkylene oxide), poly(vinyl pyrrolidinone), poly(vinyl acetate) or copolymers thereof or gelatin. In general, good results are also obtained with polyurethanes, vinyl acetate-ethylene copolymers, ethylene-vinyl chloride copolymers, vinyl acetate-vinyl chloride-ethylene terpolymers, acrylic polymers, or derivatives thereof. Preferably, the binder is a water-soluble hydrophilic polymer, most preferably polyvinyl alcohol or the like.

Other binders can also be used such as hydrophobic materials provided that they are not soluble or appreciably swellable in the organic solvent. Such binders may include, for example, poly(styrene-co-butadiene), polyurethane latex, polyester latex, poly(n-butyl acrylate), poly(n-butyl methacrylate), poly(2-ethylhexyl acrylate), copolymers of n-butylacrylate and ethylacrylate, copolymers of vinylacetate and n-butylacrylate, and the like. Mixtures of hydrophilic and latex binders are useful.

In order to impart mechanical durability to the underlying layer, crosslinkers that act upon the binder may be added in small quantities. Such an additive improves the cohesive strength of the layer. Crosslinkers such as carbodiimides, polyfunctional aziridines, aldehydes, isocyanates, epoxides, polyvalent metal cations, vinyl sulfones, pyridinium, pyridylium dication ether, methoxyalkyl melamines, triazines, dioxane derivatives, chrom alum, zirconium sulfate, boric acid or a borate salt and the like may be used. As indicated below, other conventional additives may be included in the underlying layer, which may depend on the particular use for the recording element. The underlying layer typically does not need a mordant.

As mentioned above, the porous underlying layer is located under the image-receiving layer and absorbs a substantial amount of the liquid carrier applied to the inkjet recording element, but substantially less dye or colored pigment than the overlying layer or layers.

In another embodiment of the invention, a filled layer containing light-scattering particles such as titania may be situated between a clear support material and the ink-receiving or hydrophilic absorbing layers described herein. Such a combination may be effectively used as a backlit material for signage applications. Yet another embodiment which yields an ink receiver with appropriate properties for backlit display applications results from selection of a partially voided or filled poly(ethylene terephthalate) film as a support material, in which the voids or fillers in the support material supply sufficient light scattering to diffuse light sources situated behind the image.

The support for the inkjet recording element used in the invention can be any of those usually used for inkjet receivers, such as resin-coated paper, paper, polyesters, or microporous materials such as polyethylene polymer-containing material sold by PPG Industries, Inc., Pittsburgh, Pa. under the trade name of TESLIN, TYVEK synthetic paper (DuPont Corp.), and OPPALYTE films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof, polyimides; polyamides; polycarbonates; polystyrene; polyolefins, such as polyethylene or polypropylene; polysulfones; polyacrylates; polyetherimides; and mixtures thereof. The papers listed above include a broad range of papers, from high end papers, such as photographic paper to low end papers, such as newsprint. In a preferred embodiment, polyethylene-coated or poly(ethylene terephthalate) paper is employed.

In principal, any raw paper can be used as support material. Preferably, surface sized, calendared or non-calendared or heavily sized raw paper products are used. The paper can be sized to be acidic or neutral. The raw paper should have a high dimensional stability and should be able to absorb the liquid contained in the ink without curl formation. Paper products with high dimensional stability of cellulose mixtures of coniferous cellulose and eucalyptus cellulose are especially suitable. Reference is made in this context to the disclosure of DE 196 02 793 B1, which describes a raw paper as an ink-jet recording material. The raw paper can have further additives conventionally used in the paper industry and additives such as dyes, optical brighteners or defoaming agents. Also, the use of waste cellulose and recycled paper is possible. However, it is also possible to use paper coated on one side or both sides with polyolefins, especially with polyethylene, as a support material.

The support used in the invention may have a thickness of from 50 to 500 μm, preferably from 75 to 300 μm. Antioxidants, antistatic agents, plasticizers and other known additives may be incorporated into the support, if desired.

In order to improve the adhesion of the tie layer or, in the absence of a tie layer, the ink-receiving layer, to the support, the surface of the support may be subjected to a corona-discharge treatment prior to applying a subsequent layer. The adhesion of the ink-recording layer to the support may also be improved by coating a subbing layer or glue on the support. Examples of materials useful in a subbing layer include halogenated phenols and partially hydrolyzed vinyl chloride-co-vinyl acetate polymer.

Optionally, an additional backing layer or coating may be applied to the backside of a support (i.e., the side of the support opposite the side on which the image-recording layers are coated) for the purposes of improving the machine-handling properties and curl of the recording element, controlling the friction and resistivity thereof, and the like.

Typically, the backing layer may comprise a binder and filler. Typical fillers include amorphous and crystalline silicas, poly(methyl methacrylate), hollow sphere polystyrene beads, micro-crystalline cellulose, zinc oxide, talc, and the like. The filler loaded in the backing layer is generally less than 5 percent by weight of the binder component and the average particle size of the filler material is in the range of 5 to 30 μm. Typical binders used in the backing layer are polymers such as polyacrylates, gelatin, polymethacrylates, polystyrenes, polyacrylamides, vinyl chloride-vinyl acetate copolymers, poly(vinyl alcohol), cellulose derivatives, and the like. Additionally, an antistatic agent also can be included in the backing layer to prevent static hindrance of the recording element. Particularly suitable antistatic agents are compounds such as dodecylbenzenesulfonate sodium salt, octylsulfonate potassium salt, oligostyrenesulfonate sodium salt, laurylsulfosuccinate sodium salt, and the like. The antistatic agent may be added to the binder composition in an amount of 0.1 to 15 percent by weight, based on the weight of the binder. An ink-retaining layer may also be coated on the backside, if desired.

Although the recording elements disclosed herein have been referred to primarily as being useful for inkjet printers, they also can be used as recording media for pen plotter assemblies. Pen plotters operate by writing directly on the surface of a recording medium using a pen consisting of a bundle of capillary tubes in contact with an ink reservoir.

Another aspect of the invention relates to an inkjet printing method comprising the steps of: (a) providing an inkjet printer that is responsive to digital data signals; (b) loading the inkjet printer with the inkjet recording element described above; (c) loading the inkjet printer with a pigmented inkjet ink; and (d) printing on the inkjet recording element using the inkjet ink in response to the digital data signals.

Inkjet inks used to image the recording elements of the present invention are well known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. If dyes are used in such compositions, they are typically water-soluble direct or acid type dyes. Such liquid compositions have been described extensively in the prior art including, for example, U.S. Pat. Nos. 4,381,946; 4,239,543; and 4,781,758.

Typically the colorants used in inkjet printing are anionic in character. In dye-based printing systems, the dye molecules contain anionic moieties. In pigment based printing systems, the dispersed pigments are functionalized with anionic moieties. Colorants must be fixed near the surface of the inkjet receiver in order to provide the maximum image density. In the case of pigment based printing systems, the inkjet receiver is designed with the optimum pore size in the top layer to provide effective trapping of ink pigment particles near the surface. Dye-based printing systems require a fixative or mordant in the top layer of the receiver. Polyvalent metal ions and insoluble cationic polymeric latex particles provide effective mordants for anionic dyes. Both pigment and dye based printing systems are widely available. For the convenience of the user, a universal porous inkjet receiver will comprise a dye fixative in the topmost layer.

The following examples are provided to further explain the invention.

### EXAMPLES

The following polymeric latex beads are used in the examples shown below to demonstrate the properties of the invention.

### Preparative Example 1

### Preparation of Polymeric Latex L-1

Styrene (3125 g), deionized water (9375 g), tert-dodecanethiol (187.5 g), cetylpyridinium chloride (12.5 g), were combined in an appropriately sized three-neck round bottom flask such that approximately half the volume was filled (22 L in this case). The contents were bubble degassed with nitrogen for 20 minutes and placed in a thermostatted water bath at 70° C. The paddle stirrer was adjusted to a depth of approximately midway between the surface and the bottom in order to avoid immobilization by coagulum accumulation. When the temperature of the flask contents had equilibrated at 70° C., azobis(methylpropionamidine) hydrochloride (31.25 g) was added all at once. The reaction was stirred at about 100 RPM overnight, cooled to room temperature, and filtered through a milk filter. A latex (12,264 g, 24.42% solids) was obtained. The volume average particle size was measured by quasi-elastic light scattering using a MICROTRAC UPA instrument. The molecular weights were determined by size exclusion chromatography in tetrahydrofuran against poly(methylmethacrylate) standards. The characterization data is given in Table 1.

### Preparative Example 2

### Preparation of Polymeric Latex L-2

Polymeric Latex L-2 was prepared by the same procedure described in Preparative Example 1. The following reagents were used: Styrene (375.0 g), deionized water (1125.0 g), tert-dodecanethiol (22.5 g), cetylpyridinium chloride (7.5 g), and azobis(methylpropionamidine) hydrochloride (3.75 g). 1185 g of a latex of 24.71% solids was obtained. The characterization data is given in Table 1.

### Preparative Example 3

### Preparation of Polymeric Latex L-3

Polymeric Latex L-3 was prepared by the same procedure described in Preparative Example 1 except that an additional monomer (vinylbenzyl trimethylammonium chloride) was used. The following reagents were used: Styrene (371.25 g), vinylbenzyl trimethylammonium chloride (3.75 g), deionized water (1125.0 g), tert-dodecanethiol (22.5 g), cetylpyridinium chloride (7.5 g), and azobis(methylpropionamidine) hydrochloride (3.75 g). 1263 g of latex of 25.08% solids was obtained. The characterization data is given in Table 1.

### Preparative Example 4

### Preparation of Polymeric Latex L-4

Polymeric Latex L-4 was prepared by the same procedure described in Preparative Example 3. The following reagents were used: Styrene (367.5 g), vinylbenzyl trimethylammonium chloride (7.50 g), deionized water (1125.0 g), tert-dodecanethiol (22.5 g), cetylpyridinium chloride (15.00 g), and azobis(methylpropionamidine) hydrochloride (3.75 g). Latex L-4 (1465 g, 25.65% solids) was obtained. The characterization data is given in Table 1.

### Preparative Example 5

### Preparation of Polymeric Latex L-5

Polymeric Latex L-5 was prepared by the same procedure described in Preparative Example 1. The following reagents were used: Styrene (312.5 g), deionized water (937.5 g), tert-dodecanethiol (12.5 g), cetylpyridinium chloride (1.25 g), and azobis(methylpropionamidine) hydrochloride (3.13 g). Latex L-5 (1128 g, 23.40% solids) was obtained. The characterization data is given in Table 1.

### Preparative Example 6

### Preparation of Polymeric Latex L-6

Polymeric Latex L-6 was prepared by the same procedure described in Preparative Example 1. The following reagents were used: Styrene (312.5 g), deionized water (937.5 g), tert-dodecanethiol (6.25 g), cetylpyridinium chloride (1.25 g), and azobis(methylpropionamidine) hydrochloride (3.13 g). Latex L-6 (1145 g, 23.98% solids) was obtained. The characterization data is given in Table 1.

### Preparative Example 7

### Preparation of Polymeric Latex L-7

Polymeric Latex L-7 was prepared by the same procedure described in Preparative Example 1 except that no tert-dodecanethiol was used. The following reagents were used: Styrene (187.5 g), deionized water (1062.5 g), cetylpyridinium chloride (3.75 g), and azobis(methylpropionamidine) hydrochloride (1.88 g). Latex L-7 (1162 g, 13.81% solids) was obtained. The characterization data is given in Table 1.

### Preparative Example 8

### Preparation of Polymeric Latex L-8

Polymeric Latex L-8 was prepared by the same procedure described in Preparative Example 1 except that no tert-dodecanethiol was used. The following reagents were used: Methyl methacrylate (312.5 g), deionized water (937.5 g), cetylpyridinium chloride (1.25 g), and azobis(methylpropionamidine) hydrochloride (3.13 g). Latex L-8 (1156 g, 23.97% solids) was obtained. The characterization data is given in Table 1.

TABLE 1

| Polymeric | | | Particle Size | | | |
|---|---|---|---|---|---|---|
| Latex | Description | Type | (nm) | Mn | Mw | % Solids |
| L-1 | Polystyrene beads | Invention | 122 | 3740 | 8570 | 25.64% |
| L-2 | Polystyrene beads | Invention | 97 | 3660 | 9460 | 24.71% |
| L-3 | Polystyrene | Invention | 70 | 3640 | 10200 | 25.08% |
| | copolymer beads | | | | | |
| L-4 | Polystyrene | Invention | 51 | 3450 | 10200 | 25.65% |
| | copolymer beads | | | | | |
| L-5 | Polystyrene beads | Invention | 127 | 4690 | 15300 | 23.40% |
| L-6 | Polystyrene beads | Invention | 108 | 7790 | 24700 | 23.98% |
| L-7 | Polystyrene beads | Control | 63 | 57100 | 528000 | 13.81% |
| L-8 | Polymethyl | Invention | 77 | 28800 | 73900 | 23.97% |
| | methacrylate beads | | | | | |

### Example 1

### Coating Solution A: Porous Underlying Layer A

A coating solution was prepared by dispersing 6.1 kg of CATAPAL 200 (100% solids, colloidal alumina, Sasol) in 11.76 kg of water and then slowly adding 0.255 kg of GOHSENOL GH-23 (100% solids, polyvinyl alcohol, Nippon Goshei) over 1 hour to the prop stirred mixture. The mixture heated to 90° C. for 1 hour, cooled to room temperature and 0.064 kg of 2,3-dihydroxy-1,4-dioxane (40% solids, blocked glyoxal cross-linker, Aldrich) added. Additional water was added to dilute the solution to 30% solids.

Coating Solution A was coated at room temperature via a slot hopper onto a moving web of photographic quality, non-polyethylene coated paper support. Water was removed by convective drying to give Element C-1 comprising a liquid-absorbing porous underlying layer at 25.8 g/m² dry coverage.

### Example 2

### Coating Solution B For Inventive Image-Receiving Layer

A coating solution was prepared at room temperature by dilution of 236.7 g of GOHSEFIMER K-210 (8% solids, cationically modified polyvinyl alcohol, Nippon Goshei) with 150 g of water, followed by addition of 290.8 g of Polymeric Latex 1 (24.4% solids), 18.9 g of 2,3-dihydroxy-1,4-dioxane (10% solids, blocked glyoxal cross-linker, from Aldrich) and 37.9 g of ZONYL FSN (40% solids, fluorosurfactant, Dupont). The final solids of the solution was adjusted to 12.5% with 15.6 g of water.

Coating Solution B was coated at room temperature via slot hopper onto Element C-1 and after drying gave Element C-2 at 4.26 g/m² dry coverage.

### Example 3

The Polystyrene Polymeric Latex L-1 particles were removed by immersing Element C-2 for 1 minute in 1 L of 2-butanone with gentle agitation followed by air drying to give porous Element E-1.

### Example 4

A continuous web of Element B was overcoated with a total of 104 g/m² of 2-butanone in three passes, allowing to air dry between each pass to give porous Element E-2.

### Testing of Elements:

Ink Capacity Target: Test images were printed using a CANON i960 printer with a set of pigmented inks using an ink capacity target that was designed to print cyan, magenta, yellow and black inks in 10 equal increments such that at 100% ink laydown an optical density of about 1.0 was obtained. Similarly, red, green and blue patches were obtained by overprinting the appropriate process colors together (200% in laydown). A process black was obtained by overprinting cyan, magenta and yellow inks (300% ink laydown). As the target was exiting the printer, the last step of the black only channel that was apparently dry was noted and this is referred to as the Puddling Point. In addition, a visual assessment as to the Degree of Coalescence was made. For this assessment, a rating of 1 indicates little to no coalescence was observed in the 200% & 300% RGBK patches, a rating of 2 indicates moderate coalescence, while a rating of 3 indicates severe coalescence. The results are shown in Table 2.

TABLE 2

| | | | Degree of | Degree of | Dmin | |
|---|---|---|---|---|---|---|
| | | Puddling | Coalescence* | Coalescence* | Gloss | |
| Element | Type | Point | (200% RGBK) | (300% RGBK) | (60 degree) | Description |
| C-1 | Control | 240% | 1 | 1 | 14 | Underlying Layer |
| | | | | | | Alone |
| C-2 | Control | 180% | 3 | 3 | 31 | Without Latex |
| | | | | | | Removal |
| E-1 | Invention | 200% | 1 | 1 | 23 | Latex Removal |
| | | | | | | by Immersion |
| E-2 | Invention | 210% | 1 | 2 | 29 | Latex Removal |
| | | | | | | by Solvent |
| | | | | | | Coating |

*Coalescence Key:
1 - little to none,
2: moderate,
3: severe

The data in Table 2 clearly shows an increase in the porosity of the image-receiving layer of the invention since both the Puddling Point increased and the Degree of Coalescence decreased. While an image printed on the porous underlying layer alone (Element C-1) showed a high Puddling Point and low Degree of Coalescence, the gloss of the element was undesirably low. Further, without the image-receiving layer acting as a top protective layer, the durability of the element is also compromised.

### Image Quality Target:

Test images of a colorful portrait scene were printed using a CANON i960 printer with the standard CANON i960 dye-based ink set. An assessment of the degree of ink coalescence and color to color bleed was made and is shown in Table 3. For this assessment, coalescence was rated as described above. A color to color bleed a rating of 1 indicates little to no color to color bleed was observed in RGBK patches, a rating of 2 indicates moderate color to color bleed, while a rating of 3 indicates severe color to color bleed.

TABLE 3

| | | Degree of | | |
|---|---|---|---|---|
| | | Coalescence | Color to | Dmin Gloss |
| Element | Type | (RGBK)* | Color Bleed | (60 degree) |
| C-1 | Control | 1 | 1 | 14 |
| C-2 | Control | 3 | 3 | 31 |
| E-1 | Invention | 1 | 1 | 23 |
| E-2 | Invention | 1 | 1 | 29 |

*Coalescence and Color to Color Bleed Key: 1 - little to none, 2: moderate, 3: severe

The data in Table 3 shows that the elements of the invention also show similar improvement when printed with a dye-based ink set.

### Ozone Stability Testing

Samples were printed using an EPSON R300 printer and inks to give a target that had cyan (C), magenta (M), yellow (Y), black (K) and CMY process black patches with an optical density of about 1.0. The samples were faded in an environmental chamber that was charged with 5 ppm ozone and the results are shown in Table 4.

TABLE 4

| | | | Interpolated % Fade from | | | | | | |
|---|---|---|---|---|---|---|---|---|---|
| | | Days | Starting Density of 1.0 | | | | | | |
| | | Exposed | | | | | C of | M of | Y of |
| Element | Type | (5 ppm ozone) | C | M | Y | K | CMY | CMY | CMY |
| C-1 | Control | 3 | 16.3 | 18.3 | 20.1 | 17.8 | 23.8 | 11.1 | 9.2 |
| | | 7 | 26.2 | 32.9 | 29.5 | 29.2 | 35.4 | 20.2 | 15.8 |
| C-2 | Control | 3 | 11.4 | 26.7 | 9.2 | 22.0 | 15.7 | 23.3 | 25.3 |
| | | 7 | 16.4 | 39.3 | 13.7 | 31.8 | 23.0 | 33.6 | 30.4 |
| E-1 | Invention | 3 | 7.8 | 15.9 | 3.3 | 14.9 | 15.2 | 11.6 | 9.4 |
| | | 7 | 11.3 | 28.3 | 5.4 | 23.7 | 21.1 | 20.8 | 15.9 |
| E-2 | Invention | 3 | 7.7 | 22.6 | 4.8 | 18.2 | 13.6 | 18.3 | 16.8 |
| | | 7 | 11.3 | 34.0 | 6.1 | 26.3 | 19.2 | 27.1 | 22.0 |

The data in Table 4 clearly demonstrates the reduced sensitivity to environmental ozone for the inventive elements that would translate into increased print life.

### Example 5

### Coating Solution C: Porous Underlying Layer

A coating solution was prepared by dispersing 5.7 kg of CATAPAL 200 (100% solids, colloidal alumina, Sasol) in 12.024 kg of water and then slowly adding 0.253 kg of GOHSENOL GH-23 (100% solids, polyvinyl alcohol, Nippon Goshei) over 1 hour to the prop stirred mixture. The mixture heated to 90° C. for 1 hour, cooled to room temperature and 0.036 kg of CARTABOND GHF (40% glyoxal in water, Clariant Corporation). To aid coating, surfactant OLIN 10G (10% solids, p-nonylphenoxypolyglycidol, Olin Corporation) was added at 0.1% of the total solids and additional water was added to dilute the solution to 28% solids just prior to coating.

### Coating Solution D: Control Image-Receiving Layer

A coating solution was prepared at room temperature by dilution of 50 g of GOHSEFIMER K-210 (8% solids, cationically modified polyvinyl alcohol, Nippon Goshei) with 90 g of water, followed by addition of 4.0 g of 2,3-dihydroxy-1,4-dioxane (10% solids, blocked glyoxal cross-linker, Aldrich) and 0.25 g of ZONYL FSN (40% solids, fluorosurfactant, Dupont). The final solids of the solution was adjusted to 3% with 5.75 g of water.

### Control Element C-3

Coating Solutions C and D were coated in a two-pass operation at room temperature via slot hopper onto a moving web of photographic quality, non-polyethylene coated paper support. Water was removed after each pass by convective drying to give Element C-3 with a liquid-absorbing porous underlying layer at 25.8 g/m² dry coverage and a top coat at 0.97 g/m² dry coverage.

### Example 6

### Coating Solution E for Inventive Image-Receiving Layer

A coating solution was prepared at room temperature by dilution of 47.35 g of GOHSEFIMER K-210 (8% solids, cationically modified polyvinyl alcohol, Nippon Goshei) with 25 g of water, followed by addition of 58.17 g of Polymeric Latex 1 (24.4% solids), 3.79 g of 2,3-dihydroxy-1,4-dioxane (10% solids, blocked glyoxal cross-linker, Aldrich) and 7.58 g of ZONYL FSN (40% solids, fluorosurfactant, Dupont). The final solids of the solution was adjusted to 12.5% with 8.1 g of water.

### Element E-3: Invention

Coating Solutions C and E were coated in a two-pass operation at room temperature via slot hopper onto a moving web of photographic quality, non-polyethylene coated paper support. Water was removed after each pass by convective drying to give Element E-3 with a liquid-absorbing porous underlying layer at 25.8 g/m² dry coverage and a image-receiving layer at 4.26 g/m² dry coverage.

### Example 7

### Coating Solution F for Inventive Image-Receiving Layer

A coating solution was prepared as described for Coating Solution E, except that Polymeric Latex L-2 was used in place of Polymeric Latex L-1 and the final solids was adjusted to 8%.

### Element E-4: Invention

Coating Solutions C and F were coated in a two-pass operation at room temperature via slot hopper onto a moving web of photographic quality, non-polyethylene coated paper support. Water was removed after each pass by convective drying to give Element E-4 with bottom liquid-absorbing porous underlying layer at 25.8 g/m² dry coverage and a top image-receiving layer at 4.26 g/m² dry coverage.

### Example 8

### Coating Solution G for Inventive Image-Receiving Layer

A coating solution was prepared as described for Coating Solution E, except that Polymeric Latex L-3 was used in place of Polymeric Latex L-1 and the final solids was adjusted to 7%.

### Element E-5: Invention

Coating Solutions C and G were coated in a two-pass operation at room temperature via slot hopper onto a moving web of photographic quality, non-polyethylene coated paper support. Water was removed after each pass by convective drying to give Element E-5 with bottom liquid-absorbing porous underlying layer at 25.8 g/m² dry coverage and a top image-receiving layer at 4.26 g/m² dry coverage.

### Example 9

### Coating Solution H for Inventive Image-Receiving Layer

A coating solution was prepared as described for Coating Solution E, except that Polymeric Latex L-4 was used in place of Polymeric Latex L-1 and the final solids was adjusted to 7%.

### Element E-6: Invention

Coating Solutions C and H were coated in a two-pass operation at room temperature via slot hopper onto a moving web of photographic quality, non-polyethylene coated paper support. Water was removed after each pass by convective drying to give Element E-6 with bottom liquid-absorbing porous underlying layer at 25.8 g/m² dry coverage and an image-receiving layer at 4.26 g/m² dry coverage.

### Example 10

### Coating Solution I for Inventive Top Coat

A coating solution was prepared at room temperature by dilution of 34.09 g of GOHSEFIMER K-210 (8% solids, cationically modified polyvinyl alcohol, Nippon Goshei) with 60 g of water, followed by addition of 39.89 g of Polymeric Latex 1 (25.64% solids), 2.73 g of 2,3-dihydroxy-1,4-dioxane (10% solids, blocked glyoxal cross-linker, Aldrich) and 0.0.68 g of ZONYL FSN (40% solids, fluorosurfactant, Dupont). The final solids of the solution was adjusted to 9% with 12.61 g of water.

### Element E-7: Invention

Coating Solutions C and I were simultaneously coated at room temperature via a slide hopper onto a moving web of photographic quality, non-polyethylene coated paper support. Water was removed by convective drying to give Element E-7 with a liquid-absorbing porous underlying layer at 27.1 g/m² dry coverage and a top image-receiving layer at 4.26 g/m² dry coverage.

### Example 11

### Coating Solution J for Inventive Image-Receiving Layer

A coating solution was prepared as described for Coating Solution I, except that Polymeric Latex L-5 was used in place of Polymeric Latex L-1 and the final solids was adjusted to 9%.

### Element E-8: Invention

Coating Solutions C and J were simultaneously coated at room temperature via a slide hopper onto a moving web of photographic quality, non-polyethylene coated paper support. Water was removed by convective drying to give Element E-8 with a liquid-absorbing porous underlying layer at 27.1 g/m² dry coverage and a top image-receiving layer at 4.26 g/m² dry coverage.

### Example 12

### Coating Solution K for Inventive Image-Receiving Layer

A coating solution was prepared as described for Coating Solution I, except that Polymeric Latex L-6 was used in place of Polymeric Latex L-1 and the final solids was adjusted to 8%.

### Element E-9: Invention

Coating Solutions C and K were simultaneously coated at room temperature via a slide hopper onto a moving web of photographic quality, non-polyethylene coated paper support. Water was removed by convective drying to give Element E-9 with a liquid-absorbing porous underlying layer at 27.1 g/m² dry coverage and a top image-receiving layer at 4.26 g/m² dry coverage.

### Example 13

### Coating Solution L: Control Image-Receiving Layer

A coating solution was prepared as described for Coating Solution I, except that Polymeric Latex L-7 was used in place of Polymeric Latex L-1 and the final solids was adjusted to 7%.

### Element C-4: Control

Coating Solutions C and L were simultaneously coated at room temperature via a slide hopper onto a moving web of photographic quality, non-polyethylene coated paper support. Water was removed by convective drying to give Element C-4 with a liquid-absorbing porous underlying layer at 27.1 g/m² dry coverage and a top image-receiving layer at 4.26 g/m² dry coverage.

### Example 14

### Coating Solution M for Inventive Image-Receiving Layer

A coating solution was prepared as described for Coating Solution I, except that Polymeric Latex L-8 was used in place of Polymeric Latex L-1 and the final solids was adjusted to 7%.

### Element E-10: Invention

Coating Solutions C and M were simultaneously coated at room temperature via a slide hopper onto a moving web of photographic quality, non-polyethylene coated paper support. Water was removed by convective drying to give Element E-10 with a liquid absorbing porous underlying layer at 27.1 g/m² dry coverage and a top image-receiving layer at 4.26 g/m² dry coverage.

### Testing of Elements

Elements C-3, C-4 and E-3 to E-10 were washed for 1 minute in 1 L of 2-butanone with gentle agitation followed by air drying. Test images were printed using a CANON i960 printer with a set of pigmented inks using an ink capacity target as is described in Example 4 and the Puddling Point and Degree of Coalescence is shown for the Elements in Table 5.

TABLE 5

| | | | | | | Degree of |
|---|---|---|---|---|---|---|
| | | Polymeric | Particle Size | | Puddling | Coalescence* |
| Element | Type | Latex | (nm) | Mw | Point | (300% RGBK) |
| C-3 | Control | None | n/a | n/a | 190 | 3 |
| E-3 | Invention | 1 | 122 | 8570 | 180 | 1 |
| E-4 | Invention | 2 | 97 | 9460 | 200 | 1 |
| E-5 | Invention | 3 | 70 | 10200 | 200 | 1 |
| E-6 | Invention | 4 | 51 | 10200 | 190 | 1 |
| E-7 | Invention | 1 | 122 | 8570 | 220 | 1 |
| E-8 | Invention | 5 | 127 | 15300 | 180 | 1 |
| E-9 | Invention | 6 | 108 | 24700 | 160 | 1 |
| C-4 | Control | 7 | 63 | 528000 | 50 | 3 |
| E-10 | Invention | 8 | 77 | 73900 | 190 | 1 |

*Coalescence Key:
1 - little to none,
2: moderate,
3: severe

As is seen in the above table, elements of the invention show advantaged image characteristics that are indicative of a more porous structure. For example, Elements E-3 to E-10 show less ink coalescence when compared to Element C-3 and Element C-4.

### Example 15

### Coating Solution N for Porous Underlying Layer

A coating solution was prepared as described for Coating Solution C except that the final solids of the solution was adjusted to 26% with water. Coating Solution O for Control Image-Receiving Layer

A coating solution was prepared at room temperature by dilution of 50 g of GOHSEFIMER K-210 (8% solids, cationically modified polyvinyl alcohol, Nippon Goshei) with 90 g of water, followed by addition of 4.0 g of 2,3-dihydroxy-1,4-dioxane (10% solids, blocked glyoxal cross-linker, Aldrich) and 0.25 g of ZONYL FSN (40% solids, fluorosurfactant, Dupont). The final solids of the solution was adjusted to 3% with 5.75 g of water.

### Element C-5: Control

Coating Solutions N and O were simultaneously coated at room temperature via a slide hopper onto a moving web of photographic quality, non-polyethylene coated paper support. Water was removed by convective drying to give Element C-5 with a liquid-absorbing underlying porous layer at 27.1 g/m² dry coverage and a top image-receiving layer at 0.97 g/m² dry coverage.

### Example 16

### Coating Solution P: Inventive Image-Receiving Layer

A coating solution was prepared at room temperature by dilution of 37.88 g of GOHSEFIMER K-210 (8% solids, cationically modified polyvinyl alcohol, Nippon Goshei) with 50 g of water, followed by addition of 46.53 g of Polymeric Latex L-1 (25.64% solids), 3.03 g of 2,3-dihydroxy-1,4-dioxane (10% solids, blocked glyoxal cross-linker, Aldrich) and 0.76 g of ZONYL FSN (40% solids, fluorosurfactant, from Dupont). The final solids of the solution was adjusted to 10% with 11.8 g of water.

### Element E-11: Invention

Coating Solutions N and P were simultaneously coated at room temperature via a slide hopper onto a moving web of photographic quality, non-polyethylene coated paper support. Water was removed by convective drying to give Element E-11 with a liquid-absorbing porous underlying layer at 27.1 g/m² dry coverage and a top image-receiving layer at 4.26 g/m² dry coverage.

### Example 17

### Coating Solution Q for Inventive Image-Receiving Layer

A coating solution was prepared at room temperature by dilution of 27.47 g of GOHSEFIMER K-210 (8% solids, cationically modified polyvinyl alcohol, Nippon Goshei) with 60 g of water, followed by addition of 11.91 g of CATAPAL 200 (34.6% solids, colloidal alumina, Sasol), 33.75 g of Polymeric Latex L-1 (24.42% solids), 2.20 g of 2,3-dihydroxy-1,4-dioxane (10% solids, blocked glyoxal cross-linker, Aldrich) and 0.55 g of ZONYL FSN (40% solids, fluorosurfactant, Dupont). The final solids of the solution was adjusted to 10% with 14.1 g of water.

### Element E-12: Invention

Coating Solutions N and Q were simultaneously coated at room temperature via a slide hopper onto a moving web of photographic quality, non-polyethylene coated paper support. Water was removed by convective drying to give Element E-12 with a liquid-absorbing porous underlying layer at 27.1 g/m² dry coverage and a top image-receiving layer at 5.88 g/m² dry coverage.

### Testing of Elements:

Elements C-5 and E-11 to E-12 were washed for 1 minute in 1 L of 2-butanone with gentle agitation followed by air drying. A test target that contained cyan, magenta, yellow and black patches were printed using a CANON i960 printer with the standard CANON i960 dye-based ink set. The optical density of the patches were measured using a GretagMacbeth SPECTROLINO Model No. 36.55.52 calorimeter and are recorded in Table 6.

TABLE 6

| Ele- | | Polymeric | | | | | |
|---|---|---|---|---|---|---|---|
| ment | Type | Latex | Filler | C | M | Y | K |
| C-5 | Control | None | None | 0.79 | 1.17 | 1.26 | 1.44 |
| E-11 | Invention | 1 | None | 0.83 | 1.24 | 1.40 | 1.44 |
| E-12 | Invention | 1 | CATAPAL | 0.81 | 1.30 | 1.51 | 1.50 |
| | | | 200 | | | | |
| | | | Boehmite | | | | |

As is seen in the above Table 6, the optical density of the magenta, yellow and black patches were increased when colloidal alumina filler was included in the top layer. Similar effects were seen with fumed aluminas and fumed silicas used in combination with the latex porogens of the invention.

### Example 18

### Element E-13: Invention (Also Comparison for E-14 with Supplemental Porous Underlying Layer)

Element E-13 was produced as is described for Element E-3 in Example 6 to give a liquid-absorbing porous underlying layer at 25.8 g/m² dry coverage and a top image-receiving layer at 4.26 g/m² dry coverage.

### Example 19

### Coating Solution R for Supplemental Porous Underlying Layer

A coating solution was prepared at room temperature by dilution of 8.45 g of GOHSEFIMER K-210 (8% solids, cationically modified polyvinyl alcohol, Nippon Goshei) with 100 g of water, followed by addition of 0.84 g of CARTACOAT S2 (100% solids, amorphous silica, Clariant), 18.34 g of CARTACOAT K 302 C (32.24% solids, cationized colloidal silica, Clariant) and 0.68 g of 2,3-dihydroxy-1,4-dioxane (10% solids, blocked glyoxal cross-linker, Aldrich). The final solids of the solution was adjusted to 5% with 21.7 g of water.

### Element E-14: Invention

Coating Solutions C (bottom), R (middle) and E (top) were sequentially coated at room temperature via a slot hopper onto a moving web of photographic quality, non-polyethylene coated paper support. After each pass, water was removed by convective drying to give Element E-14 with a bottom liquid-absorbing porous underlying layer at 25.8 g/m² dry coverage, a supplemental (middle) porous underlying layer at 2.39 g/m² dry coverage and a image-receiving layer at 4.26 g/m² dry coverage.

### Testing of Elements E-14 and E-15

Elements E-14 and E-15 were washed for 1 minute in 1 L of 2-butanone with gentle agitation followed by air drying. Test images were then printed with either the Ink Capacity Target using a CANON i960 printer and a pigmented ink set or the Image Quality Target using a CANON i960 printer and the standard CANON i960 dye-based ink set, as is described in Example 4. The degree of coalescence was then evaluated as previously described and the results are shown in Table 7.

TABLE 7

| | | Degree of | Degree of |
|---|---|---|---|
| | | Coalescence* | Coalescence* |
| | | (Pigmented Ink | (Canon Ink Set, |
| Element | Type | Set, 300% RGBK) | RGBK) |
| E-14 | Interlayer Not | 2 | 2 |
| | present | | |
| E-15 | Interlayer | 1 | 1 |
| | present | | |

*Coalescence Key: 1 - little to none, 2: moderate, 3: severe

As is seen above, use of the interlayer (supplemental/middle porous underlying layer) led to even greater reduced coalescence for both pigmented and dye-based ink sets. Similar results would be expected with interlayers formulated with other fillers.

The invention has been described with reference to a preferred embodiment. However, it will be appreciated that variations and modifications can be effected by a person of ordinary skill in the art without departing from the scope of the invention.

1. A method of making a porous swellable inkjet recording element comprising the steps of:
(a) providing a support;
(b) coating on the support a first aqueous composition comprising particles and a polymeric binder to form at least one porous underlying layer when dried;
(c) coating above the at least one porous underlying layer a second aqueous composition comprising a hydrophilic polymeric binder and a dispersion of a water-insoluble polymeric latex to form a non-porous upper layer when dried;
(d) either sequentially or simultaneously drying the coated first aqueous coated composition to form a porous underlying layer, either before or after coating the second aqueous composition, and drying the second aqueous composition to form a non-porous upper layer, thereby forming a coated support that is a manufacturing intermediate of the inkjet recording element; and
(e) applying, to the coated support of step (d), solvent for the water-insoluble polymeric latex, for a sufficient amount of time, to solubilize and transport a substantial portion of the water-insoluble polymeric latex from the non-porous upper layer, thereby forming after solvent evaporation an inkjet recording element comprising an image-receiving layer comprising a porous water-swellable polymeric matrix.

2. The method of claim 1 wherein the amount of solvent is applied in an amount not exceeding an amount that would run off the surface of the inkjet recording element or not exceeding an amount that would saturate the coated support of step (d).

3. The method of claim 2 wherein the solvent is sprayed onto the non-porous upper layer.

4. The method of claim 1 wherein the solvent applied in step (e) causes sufficient water-insoluble polymeric latex to migrate to the at least one porous underlying layer to render the non-porous upper layer effectively porous.

5. The method of claim 1 wherein the coated support in step (e) is immersed in solvent to remove water-insoluble polymeric latex from the inkjet recording element.

6. The method of claim 1 wherein the coated support is a continuous web, having a top surface of which is facing substantially downwards towards a source of solvent that is sprayed towards the coated support, such that gravity facilitates the removal of solvent and dissolved water-insoluble polymeric latex from the coated support.

7. The method of claim 1 wherein the water-insoluble polymeric latex has a particle size in dispersion of less than 1 micrometer.

8. The method of claim 1 wherein the water-insoluble polymeric latex is effectively soluble in the solvent.

9. The method of claim 1 wherein the weight average molecular weight of the water-insoluble polymeric latex is sufficiently low that the applied solvent is capable of effectively solubilizing and transporting a substantial portion of the water-insoluble polymeric latex from the non-porous upper layer.

10. The method of claim 1 wherein the weight average molecular weight of water-insoluble polymeric latex is less than 250,000.

11. The method of claim 10 wherein the weight average molecular weight of water-insoluble polymeric latex is less than 100,000.

12. The method of claim 11 wherein the water-insoluble polymeric latex is polystyrene or a copolymer thereof and the weight average molecular weight is less than 25,000.

13. The method of claim 1 wherein the water-insoluble polymeric latex is a copolymer or polymer comprising monomeric units that are the reaction product of monomers selected from the group consisting of acrylic, methacrylic, and/or styrenic monomers.

14. The method of claim 1 wherein the water-insoluble polymeric latex is a linear or branched polymer, essentially non-crosslinked.

15. The method of claim 1 wherein the hydrophilic polymer binder in the image-receiving layer is selected from the group consisting of gelatin, polyvinyl pyrrolidinone (PVP), and poly(vinyl alcohol), and derivatives and copolymers of the foregoing and combinations thereof.

16. The method of claim 1 wherein the second aqueous composition for the image-receiving layer comprises crosslinker for the hydrophilic polymeric binder.

17. The method of claim 1 wherein the solvent is capable of effectively solubilizing the water-insoluble latex while not solubilizing the hydrophilic polymeric binder which is optionally crosslinked.

18. The method of claim 1 wherein the solvent comprises at least one organic-solvent compound.

19. The method of claim 18 wherein the at least one organic-solvent compound is not of greater polarity than acetone.

20. The method of claim 18 wherein the solvent comprises one or more organic-solvent compounds all of which have a boiling point between 40° C. and 120° C.

21. The method of claim 1 wherein the weight ratio of water-insoluble polymeric latex to hydrophilic polymeric binder is from 10:1 to 1:1.

22. The method of claim 1 wherein the at least one porous underlying layer is 20 to 50 micrometers and the image-receiving layer is relatively thin compared to the porous underlying layer and has a thickness less than 10 μm.

23. The method of claim 1 wherein there are at least two porous underlying layers including a latex-absorbing layer for absorbing the water-insoluble polymeric latex when organic-containing solvent is applied to the upper surface of the coated support, which latex-absorbing layer is between the image-receiving layer and a lower porous underlying layer, which latex-absorbing layer is relatively thin and has a relatively smaller average pore diameter compared to the lower porous underlying layer.

24. An inkjet printing process comprising the steps of:
(A) providing an inkjet printer that is responsive to digital data signals;
(B) loading the inkjet printer with an inkjet recording element made by the method of claim 1;
(C) loading the inkjet printer with an inkjet ink composition; and
(D) printing on the inkjet recording element using the inkjet ink composition in response to the digital data signals.

25. An inkjet recording element comprising a support and coated over the support in order:
(a) at least one porous underlying layer comprising less than 35 percent by weight of a polymeric binder, greater than 65 percent by weight of particles and, interstitially located in pores formed by the particles, water-insoluble polymeric latex;
(b) a porous water-swellable image-receiving layer comprising at least one water-swellable hydrophilic polymer and same said water-insoluble polymeric latex; and
wherein there is a gradient of the water-insoluble polymeric latex in the porous underlying layer, immediately adjacent the porous underlying layer, that decreases in the direction of the support, resulting from diffusion in an organic-containing solvent of the water-insoluble polymeric latex when organic solvent applied to an upper surface of the coated support used to make an inkjet recording element.

26. The method of claim 25 wherein the porous water-swellable image-receiving layer comprises less water-insoluble polymeric latex in a top half of the layer, and the at least one porous underlying layer comprises more water-insoluble polymeric latex in a top half of the layer.

27. The inkjet recording element of claim 25 wherein the majority of the porosity of the porous water-swellable image-receiving layer is formed by voids, walls of which voids are mainly formed by material of the water-swellable image-receiving layer.

28. The inkjet recording element of claim 25 wherein the image-receiving layer comprises between 10 to 80 percent voids based on the total volume of the layer.

29. The inkjet recording element of claim 25 wherein the at least one porous underlying layer, between the image-receiving layer and the support, comprises between 50 and 99 percent by weight of particles of one or
more inorganic or organic particles, wherein the average pore size in the at least one porous underlying layer is 10 to 1000 nm.

30. The inkjet recording element of claim 25 comprising at least two porous underlying layers, including a latex-absorbing layer for absorbing the water-insoluble polymeric latex when organic-containing solvent is applied to an upper surface of the coated support during its manufacture, which latex-absorbing layer is between the image-receiving layer and a lower porous underlying layer, which latex-absorbing layer is relatively thin and has a relatively smaller average pore diameter compared to the lower porous underlying layer.

31. The inkjet recording element of claim 25 wherein the at least one porous underlying layer comprises one or more inorganic particles selected from the group consisting of precipitated calcium carbonate, silica gel, hydrated or unhydrated metallic or semi-metallic oxide, or combinations thereof.

32. The inkjet recording element of claim 25 wherein the at least one porous underlying layer comprises less than 15 weight percent binder and wherein the volume ratio of the particles to the polymeric binder is from about 1:1 to about 15:1.

33. The inkjet recording element of claim 25 further comprising, in the image-receiving layer, non-solvent-removable solid particles for enhancing void formation
